(19) United States
(12) Patent Application Publication
(10) Pub. No.: US 2013/0132478 A1
(43) Pub. Date: May 23, 2013

(54) Establishing Communication Among Parties Based on Location

(71) Applicants: Sean Belanger, Largo, FL (US); Peter Hayes, Clearwater, FL (US)

(72) Inventors: Sean Belanger, Largo, FL (US); Peter Hayes, Clearwater, FL (US)

(73) Assignee: CSDRVS, Clearwater, FL (US)

(21) Appl. No.: 13/598,788

(22) Filed: Aug. 30, 2012

Related U.S. Application Data
(60) Provisional application No. 61/528,962, filed on Aug. 30, 2011.

(51) Int. Cl. H04L 29/06; H04W 12/06

(52) U.S. Cl. CPC H04L 65/403; H04W 12/06
USPC 709/204; 726/5

(57) ABSTRACT

Disclosed are various embodiments for transmitting a location of a first client device to a server device. A communication request is transmitted from the first client device that requests a conference with a second client device. A conference is established with the second client device using a communications link. The communications link facilitates the conference being established over a network between the first and second client devices.

### CROSS REFERENCE TO RELATED APPLICATION

This application claims priority to, and the benefit of, U.S. Provisional Patent Application entitled, “ESTABLISHING COMMUNICATION AMONG PARTIES BASED ON LOCATION,” having Ser. No. 61/528,962, filed on Aug. 30, 2011, which is incorporated by reference in its entirety.

### BACKGROUND

Ubiquitous consumer devices such as tablet computers, laptops, smartphones and desktop computers have become important tools for communications. However, the criteria used to identify a target party with which to establish communications may be limited in scope.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a flowchart illustrating one example of functionality implemented as portions of a function controller executed in a client in the networked environment of FIG. 1 according to various embodiments of the present disclosure.

FIG. 3 is a drawing of a networked environment according to other various embodiments of the present disclosure.

FIG. 4 is a flowchart illustrating another example of functionality implemented as portions of a function controller executed in a client in the networked environment of FIG. 3 according to various embodiments of the present disclosure.

FIG. 5 is a schematic block diagram that provides one example illustration of a server employed in the networked environment of FIGS. 1 and 3 according to various embodiments of the present disclosure.

FIG. 6 is a schematic block diagram that provides one example illustration of a client employed in the networked environment of FIGS. 1 and 3 according to various embodiments of the present disclosure.

### DETAILED DESCRIPTION

The present disclosure relates to establishing communications among parties based on the location of one or more parties. As a non-limiting example, client ‘A’ connects to the server using the communications application. Upon connecting, client A provides the present geolocation information, as well as communications capabilities of the client device and client preferences. The geolocation as reported by client A is translated by the server into various formats such as latitude/longitude, city/state/country, landmark, postal code, telephone area code, etc. Once the user is willing to receive communications, client A communicates this preference to the server via the communications application.

Client ‘Z’ wishes to communicate with a party in the vicinity of Waimea Bay, Hawaii. Using the application on the client device, client Z may search for other parties in the vicinity of the location sought by specifying the desired location in either of a variety of formats such as latitude/longitude, city/state/country, landmark, postal code, or telephone area code. Client Z discovers that client A is within an acceptable vicinity of Waimea Bay, Hawaii and wishes to communicate with client A. Client Z will submit a communications request to the server to establish a communication link between client A and client Z using the server as an intermediary. If the server resources permit the provisioning of the session, the server will issue a communications request to client A on behalf of client Z. If client A accepts the request, each client establishes a communication link with the server, which then establishes a communications session between the clients with each client using the server as an intermediary.

In a further non-limiting example, client ‘A’ connects to the server using the communications application. Upon connecting, client A provides the present geolocation information, as well as communications capabilities of the client device and client preferences. The geolocation as reported by client A is translated by the server into various formats such as latitude/longitude, city/state/country, landmark, postal code, telephone area code, etc. Once the user is willing to receive communications, client A communicates this preference to the server via the communications application.

Client ‘Z’ wishes to communicate with a party in the vicinity of Waimea Bay, Hawaii. Using the application on the client device, client Z may search for other parties in the vicinity of the location sought by specifying the desired location in either of a variety of formats such as latitude/longitude, city/state/country, landmark, postal code, or telephone area code. Client Z discovers that client A is within an acceptable vicinity of Waimea Bay, Hawaii and wishes to communicate with client A. Client Z will first obtain from the server the network and application information necessary to communicate directly with client A. Using the network and application information, client Z will submit a communications request to client A to establish a communication link between client A and client Z. If client A accepts the request, the clients establish a communication link directly between them, which then establishes a communications session between the clients.

### First Embodiment

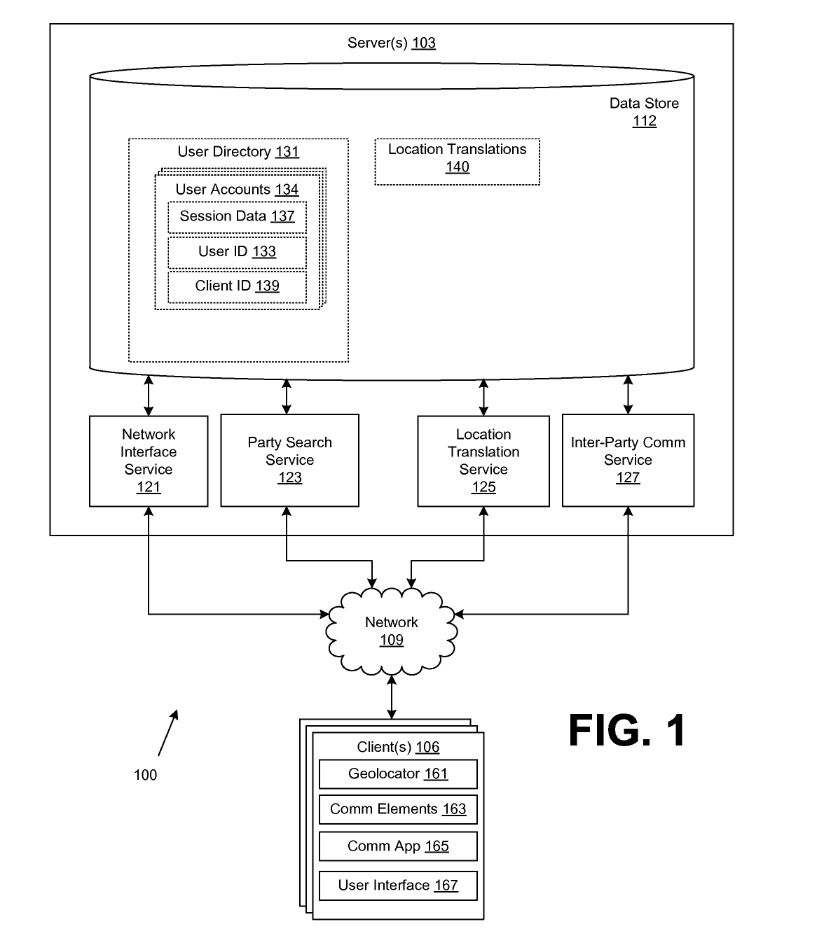

The present disclosure provides various embodiments of a network environment 100. With reference to FIG. 1, shown is a network environment 100 according to a first embodiment. The network environment 100 includes a server 103, a client 106 and a network 109. The network 109 includes, for example, the Internet, intranets, extranets, wide area networks (WANs), local area networks (LANs), wired networks, wireless networks, or other suitable networks, etc., or any combination of two or more such networks.

The server 103 may comprise, for example, a server computer or any other system providing computing capability. Alternatively, a plurality of servers 103 may be employed that are arranged, for example, in one or more server banks or computer banks or other arrangements. For example, a plurality of servers 103 together may comprise a cloud computing resource, a grid computing resource, and/or any other distributed computing arrangement. Such servers 103 may be located in a single installation or may be distributed among many different geographical locations. For purposes of convenience, the server 103 is referred to herein in the singular. Even though the server is referred to in the singular, it is understood that a plurality of servers 103 may be employed in the various arrangements as described above.

Various applications and/or other functionality may be executed in the server 103 according to various embodiments. Also, various data is stored in a database 112 that is accessible to the server 103. The database 112 may be representative of a plurality of databases as can be appreciated. The data stored in the database 112, for example, is associated with the operation of the various applications and/or functional entities described below.

The components executed on the server 103, for example, include a network interface service 121, search service 123, location translation service 125, inter-party communication service 127 and other applications, services, processes, systems, engines, or functionality not discussed in detail herein.

The network interface service 121 provides a network presence for the client 106 and other devices to access the search service 123, inter-party communication service 127 and the user directory 131. To this end, the network interface service 121 may include a network page server to serve data such as network pages to the client 106 over a protocol such as hypertext transfer protocol (HTTP), simple object access protocol (SOAP), and/or other protocols. Such a network page server may comprise a commercially available network page server such as, for example, Apache® HTTP Server, Microsoft® Internet Information Services (IIS), and/or other network page servers.

The search service 123 is executed to facilitate identifying parties with which to establish communications with the client 106. To this end, the search service 123 may be accessed from the client 106 using the communications application 165, network browser or other client application. A search may be conducted by specifying one more geolocation identifiers, such as latitude/longitude, city/state/country, landmark, postal code, telephone area code, etc. and may further include the specification of an acceptable vicinity and orientation. The result of the search is a list of client ids 139 corresponding to the specified search parameters.

The location translation service 125 is executed to facilitate translating a set of provided coordinates into other coordinate systems that may be searched. In order to translate among coordinate systems, the location translation service 125 relies upon location translations 140 to provide the boundaries that may be used in various coordinate systems. As a non-limiting example, given the latitude N 21° 38.45′ N and longitude W 158° 3.8′, the location translation service 125 may return the coordinates as in the vicinity of the landmark Waimea Bay in Haleiwa, Hawaii, USA 96712 having the telephone area code 808.

The inter-party communication service 127 is executed to facilitate establishing a communications session among clients 106 using the server 103 as an intermediary. In one embodiment, the inter-party communications service 127 may support the traditional bi-directional communications between two clients. In a further embodiment, the inter-party communications service 127 may support multi-party conferences having more than two people and/or an “observer” mode with a limited number of parties communicating, while the other parties are permitted to observe the communications.

To this end, the inter-party communication service 127 may support communications using video, audio, instant message, Short Message Service (SMS), Multimedia Messaging Service (MMS), email or other communications services. To offer these services, the inter-party communication service 127 may support communications protocols such as, for example, H.264, H.263, session initiation protocol (SIP), extensible messaging and presence protocol (XMPP), global system for mobile communications (GSM), simple mail transfer protocol (SMTP), etc.

The data stored in the database 112 includes, for example, the user directory 131 and the location translations 140. The location translations 140 provide the boundaries that may be used in various coordinate systems. As a non-limiting example, the location translations 140 may contain an entry for the state of Hawaii that translates to being within the boundary of the United States, within area code 808, within the coordinates, N 18° 55′ to 28° 27′ N by W 154° 48′ to 178° 22′, etc.

The user directory 131 contains the users who are recognized by the service. The user directory 131 may contain user accounts 134 that may include information about user accounts associated with the network interface service 121. Account settings may be employed to specify and track various settings and other functionality with respect to a given account such as passwords, security credentials, billing information, and/or other data. The user accounts 134 may further include a user identifier (ID) 133, session data 137 and client IDs 139.

The user ID 133 facilitates identifying the client 106 with an associated user account 134. The user ID 133 may be, for example, a telephone number, email address, user name, or other any other identifier that may be used to associate a client 106 with a specific user account 134. The session data 137 may contain various information about the session(s) established with the client, such as application version, communication methods supported, protocols supported, network address, etc.

The client ID 139 facilitates identifying the specific client 106 from which a user is connected to the network interface service 121. As a non-limiting example, one user account 134 may be simultaneously connected to the network interface service 121 through multiple clients 106, such as a tablet computer, a smart phone and a desktop computer, each of which may have different communication capabilities and preferences. The client ID 139 that may be unique to a particular client device facilitates establishing the communications link by enabling an individual device to be addressed.

The client 106 is representative of a plurality of client devices that may be coupled to the network 109. The client 106 may be, for example, a processor-based system, such as a desktop computer, a laptop computer, a personal digital assistant, a mobile communication device (e.g., cellular telephone, smartphone, etc.), tablet computer or other devices with like communications capabilities. The client 106 may further contain a geolocator 161, communications elements 163, a communications application 165, and a user interface 167.

The geolocator 161 may provide the location of the client 106 according to one or more coordinate systems. As a non-limiting example, for a client 106 with a global positioning system (GPS) receiver, the geolocator 161 may provide latitude/longitude. The communications elements 163 may provide the ability to communicate with another party using the client 106. As a non-limiting example, the video camera, display, microphone, speakers and keyboard in a client 106 are all communications element 163.

The communications application 165 facilitates establishing communications between the client 106 and other parties. To this end, the communications application 165 may be configured to supply the user ID 133 of the client 106 in order to authenticate with the network interface service 121. Additionally, the communications application 165 may support sending and receiving communications requests, as well as searching for other parties based on location and/or other criteria. Furthermore, the communications application 165 facilitates establishing communications links and sessions with the inter-party communications service 127.

The client 106 may also provide a user interface 167 for presenting visual representations of information, functionality, control elements, etc. to facilitate control and interaction of the client 106. The user interface 167 may also provide auditory and tactile alerts, such as chimes, vibrations, or other alerts that may be sensed by the user.

Next, a general description of the operation of the various components of the networked environment 100 is provided. To begin, a user of the client 106 initiates service with the network interface service 121. The user may initiate service, for example, by downloading and installing the communications application 165 on the client 106. During execution, the communications application 165 may be configured to supply the user ID 133 of the client 106 in order to authenticate with the network interface service 121. Upon being authenticated and authorized, the communications application 165 provides the location of the client 106 as determined by the geolocator 161. Additionally, the communications application 165 may report the communications capabilities and preferences of the client to the network interface service 121.

The communications application 165 may run, for example, as a background process or daemon so as to not interfere with other potential functions of the client 106 until desired to do so. While running on the client 106, the communications application 165 may continue to periodically send geolocation updates to the network interface service 121. Alternatively or in addition, the network interface service 121 may periodically request a location update from the client 106 in order to ensure the client 106 is still active and the reported geolocation information is current.

If the preferences of the client 106 and/or user indicate, then the client 106 may receive communications requests from other parties. The communication requests may contain information about the other party such as name, location, language, type of communication sought (e.g. video, audio, instant message, multiparty call, etc.), purpose for the communication, etc. Upon receiving such a request, the communications application 165 on the client 106 may provide notice of the request and prompt the user to accept or reject the request.

If the communication request is accepted by the user, then the communications application 165 notifies the network interface service 121 of the acceptance and begins negotiating with the inter-party communication service 127 to establish a communications link between the client 106 and the server 103. The inter-party communications service 127 may further establish a communications link between the server 103 and the one or more other parties participating in the communication session. The communication session among the client 106 and the other parties may occur via the established communication links using the server 103 as an intermediary. When the client 106 wishes to exit the communication session, the communications application 165 notifies the network interface service 121 and negotiates with the inter-party communication service 127 to terminate the communication link to the client 106.

The user may wish to search for other parties with which to communicate. Using the communications application 165, the user may search for other parties based on location, such as latitude/longitude, city/state/country, landmark, postal code, or telephone area code, etc. and/or other criteria, such as name, language, communication capabilities, etc. Alternatively or in addition, the user may use a web browser or other application to access the network interface service 121 and carry out the search. Once the search query is issued to the network interface service 121 by communications application 165 or other application, the query is forwarded to the search service 123.

The search service 123 may then use the location translation service 125 to translate the location specified in the query, as well as any vicinity specified, into the bounds of the location sought in a variety of coordinate systems that may be reported by other parties. The location translation service 125 may refer to the location translations 140 as a reference to determine the bounds of specified locations. Using the location bounds in a variety of coordinate systems, the search service identifies the user accounts 134 that are willing to receive calls that are also within the bounds of the location specified.

As a non-limiting example, if a user sought to find another party within five miles of Haleiwa, Hawaii, USA, then the location translation service 125 would identify the bounds of this location as specified in various coordinate systems. Therefore, the search service 123 would identify a party reporting a location of N 21° 38.45′, W 158° 3.8′ as being within the location specified, even though the locations were specified through different coordinate systems. The search service 123 may further filter the user accounts identified based on search criteria specified by the user, such as name, language, communication capabilities, etc.

Once a target party is identified, the communications application 165 may send a communication request to the network interface service 121. The communication request may contain information about the other party such as name, location, language, type of communication sought (e.g. video, audio, instant message, multiparty call, etc.), purpose for the communication, etc.

If the server 103 resources permit the provisioning of the session, then the server 103 will issue a communications request to the target party on behalf of client 106. If the communication request is accepted by the user, then the communications application 165 notifies the network interface service 121 of the acceptance and begins negotiating with the inter-party communication service 127 to establish a communications link between the client 106 and the server 103. The inter-party communications service 127 may further establish a communications link between the server 103 and the one or more other parties participating in the communication session. The communication session among the client 106 and the other parties may occur via the established communication links using the server 103 as an intermediary. When the client 106 wishes to exit the communication session, the communications application 165 notifies the network interface service 121 and negotiates with the inter-party communication service 127 to terminate the communication link to the client 106.

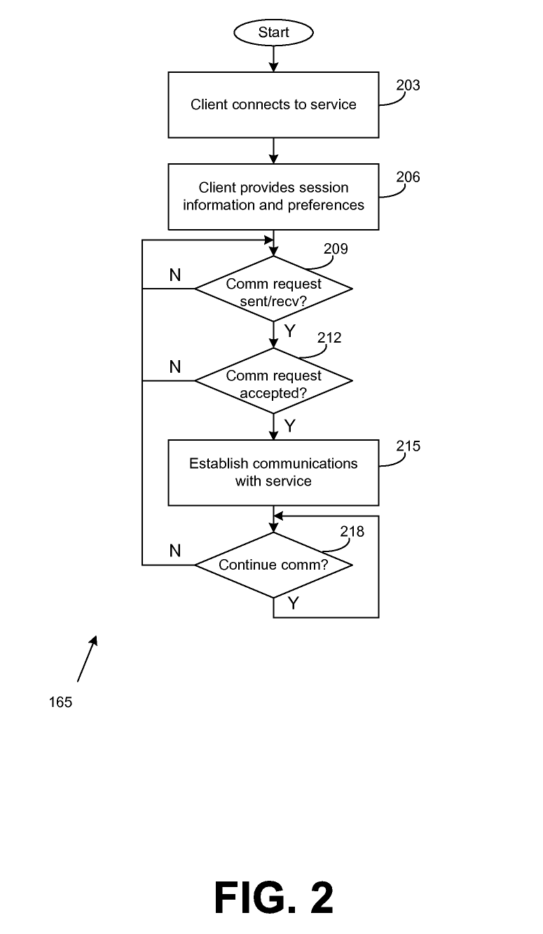

Referring next to FIG. 2, shown is a flowchart that provides one example of the operation of a portion of the communications application 165 according to various embodiments. It is understood that the flowchart of FIG. 2 provides merely an example of the many different types of functional arrangements that may be employed to implement the operation of the portion of the communications application 165 as described herein. As an alternative, the flowchart of FIG. 2 may be viewed as depicting an example of steps of a method implemented in the client 106 (FIG. 1) according to one or more embodiments.

Beginning with box 203, the communications application 165 (FIG. 1) initiates service with to the network interface service 121 (FIG. 1). During execution, the communications application 165 may be configured to supply the user ID 133 (FIG. 1) in order to authenticate with the network interface service 121. Next to box 206, the communications application 165 provides the location of the client 106 (FIG. 1) as determined by the geolocator 161 (FIG. 1). Additionally, the communications application 165 may report the communications capabilities and preferences of the client to the network interface service 121.

Moving to box 209, the communications application 165 may send and/or receive communications requests to/from other parties. The communication requests may contain information about the other party such as name, location, language, type of communication sought (e.g. video, audio, instant message, multiparty call, etc.), purpose for the communication, etc. Upon receiving such a request, the communications application 165 on the client 106 may provide notice of the request and prompt the user to accept or reject the request.

Next, box 212 contemplates a communications request sent by the client 106 being accepted by another party, or, alternatively, the client 106 accepting a communications request sent by another party.

Moving to box 215, the communication request is accepted, the network interface service 121 is notified and the communications application 165 begins negotiating with the inter-party communication service 127 (FIG. 1) to establish a communications link between the client 106 and the server 103 (FIG. 1). The inter-party communications service 127 may further establish a communications link between the server 103 and the one or more other parties participating in the communication session. The communication session among the client 106 and the other parties may occur via the established communication links using the server 103 as an intermediary.

Moving to box 218, when the client 106 wishes to exit the communication session, the communications application 165 notifies the network interface service 121 and negotiates with the inter-party communication service 127 to terminate the communication link to the client 106. Thereafter, the process continues until it is interrupted.

### Second Embodiment

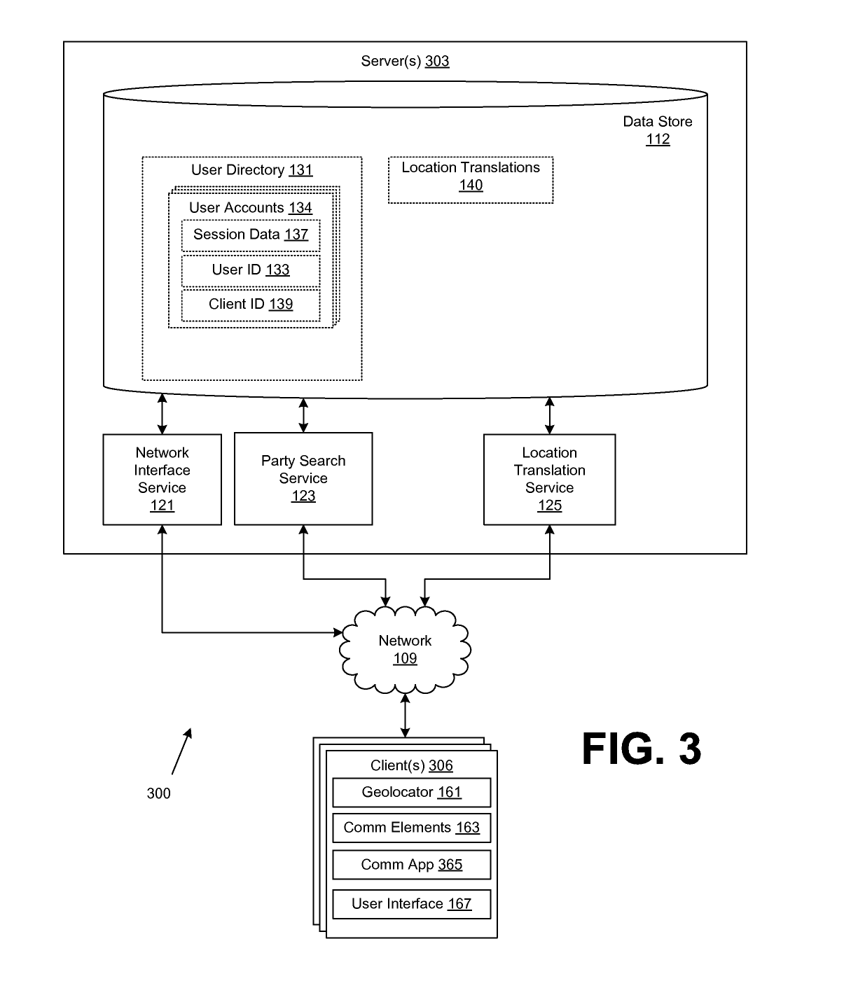

With reference to FIG. 3, shown is a network environment 300 according to a second embodiment. The network environment 300 includes the server 303, the client 306, and the network 109 as described in the first embodiment above.

The server 303 may comprise, for example, a server computer or any other system providing computing capability. Alternatively, a plurality of servers 303 may be employed that are arranged, for example, in one or more server banks or computer banks or other arrangements. For example, a plurality of servers 303 together may comprise a cloud computing resource, a grid computing resource, and/or any other distributed computing arrangement. Such servers 303 may be located in a single installation or may be distributed among many different geographical locations. For purposes of convenience, the server 303 is referred to herein in the singular. Even though the server is referred to in the singular, it is understood that a plurality of servers 303 may be employed in the various arrangements as described above.

Various applications and/or other functionality may be executed in the server 303 according to various embodiments. Also, various data is stored in a database 112 that is accessible to the server 303. The database 112 may be representative of a plurality of databases as can be appreciated. The data stored in the database 112, for example, is associated with the operation of the various applications and/or functional entities described below.

The components executed on the server 303, for example, include a network interface service 121, search service 123, location translation service 125, and other applications, services, processes, systems, engines, or functionality not discussed in detail herein.

The network interface service 121 provides a network presence for the client 306 and other devices to access the search service 123, inter-party communication service 127 and the user directory 131. To this end, the network interface service 121 may include a network page server to serve data such as network pages to the client 306 over a protocol such as hypertext transfer protocol (HTTP), simple object access protocol (SOAP), and/or other protocols. Such a network page server may comprise a commercially available network page server such as, for example, Apache® HTTP Server, Microsoft® Internet Information Services (IIS), and/or other network page servers.

The search service 123 is executed to facilitate identifying parties with which to establish communications with the client 306. To this end, the search service 123 may be accessed from the client 306 using the communications application 365, network browser or other client application. A search may be conducted by specifying one more geolocation identifiers, such as latitude/longitude, city/state/country, landmark, postal code, telephone area code, etc. and may further include the specification of an acceptable vicinity and orientation. The result of the search is a list of client ids 139 corresponding to the specified search parameters.

The location translation service 125 is executed to facilitate translating a set of provided coordinates into other coordinate systems that may be searched. In order to translate among coordinate systems, the location translation service 125 relies upon location translations 140 to provide the boundaries that may be used in various coordinate systems. As a non-limiting example, given the latitude N 21° 38.45′ N and longitude W 158° 3.8′, the location translation service 125 may return the coordinates as in the vicinity of the landmark Waimea Bay in Haleiwa, Hawaii, USA 96712 having the telephone area code 808.

The data stored in the database 112 includes, for example, the user directory 131 and the location translations 140. The location translations 140 provide the boundaries that may be used in various coordinate systems. As a non-limiting example, the location translations 140 may contain an entry for the state of Hawaii that translates to being within the boundary of the United States, within area code 808, within the coordinates, N 18° 55′ to 28° 27′ N by W 154° 48′ to 178° 22′, etc.

The user directory 131 contains the users who are recognized by the service. The user directory 131 may contain user accounts 134 that may include information about user accounts associated with the network interface service 121. Account settings may be employed to specify and track various settings and other functionality with respect to a given account such as passwords, security credentials, billing information, and/or other data. The user accounts 134 may further include a user ID 133, session data 137 and client IDs 139.

The user ID 133 facilitates identifying the client 306 with an associated user account 134. The user ID 133 may be, for example, a telephone number, email address, user name, or other any other identifier that may be used to associate a client 306 with a specific user account 134. The session data 137 may contain various information about the session(s) established with the client 306, such as application version, communication methods supported, protocols supported, network address, etc.

The client ID 139 facilitates identifying the specific client 306 from which a user is connected to the network interface service 121. As a non-limiting example, one user account 134 may be simultaneously connected to the network interface service 121 through multiple clients 306, such as a tablet computer, a smart phone and a desktop computer, each of which may have different communication capabilities and preferences. The client ID 139 that may be unique to a particular client device facilitates establishing the communications link by enabling an individual device to be addressed.

The client 306 is representative of a plurality of client devices that may be coupled to the network 109. The client 306 may comprise, for example, a processor-based system such as a computer system. Such a computer system may be embodied in the form of a desktop computer, a laptop computer, a personal digital assistant, a smartphone, a cellular telephone, tablet computer or other devices with like communications capabilities. The client may further contain a geolocator 161, communications elements 163, a communications application 365, and a user interface 167.

The geolocator 161 may provide the location of the client 306 according to one or more coordinate systems. As a non-limiting example, for a client 306 with a Global Positioning System (GPS) receiver, the geolocator 161 may provide latitude/longitude. The communications elements 163 may provide the ability to communicate with another party using the client 306. As a non-limiting example, the video camera, display, microphone, speakers and keyboard in a client 306 are all communications element 163.

The communications application 365 facilitates establishing communications between the client 306 and other parties. To this end, the communications application 365 may be configured to supply the user ID 133 of the client 306 in order to authenticate with the network interface service 121. To this end, the communications application 365 may support communications using video, audio, instant message, Short Message Service (SMS), Multimedia Messaging Service (MMS), email or other communications services. To offer these services, the communications application 365 may support communications protocols such as, for example, H.264, H.263, Session Initiation Protocol (SIP), eXtensible Messaging and Presence Protocol (XMPP), Global System for Mobile Communications (GSM), Simple Mail Transfer Protocol (SMTP), etc.

The communications application 365 may support sending and receiving communications requests, as well as searching for other parties based on location and/or other criteria. Furthermore, the communications application 365 facilitates establishing communications links and sessions directly with other clients 306.

The client 306 may also provide a user interface 167 for presenting visual representations of information, functionality, control elements, etc. to facilitate control and interaction of the client 306. The user interface 167 may also provide auditory and tactile alerts, such as chimes, vibrations, or other alerts that may be sensed by the user.

Next, a general description of the operation of the various components of the networked environment 300 is provided. To begin, a user of the client 306 initiates service with the network interface service 121. The user may initiate service, for example, by downloading and installing the communications application 365 on the client 306. During execution, the communications application 365 may be configured to supply the user ID 133 of the client 306 in order to authenticate with the network interface service 121. Upon being authenticated and authorized, the communications application 365 provides the location of the client 306 as determined by the geolocator 161. Additionally, the communications application 365 may report the communications capabilities and preferences of the client to the network interface service 121.

The communications application 365 may run, for example, as a background process or daemon so as to not interfere with other potential functions of the client 306 until desired to do so. While running on the client 306, the communications application 365 may continue to periodically send geolocation updates to the network interface service 121. Alternatively or in addition, the network interface service 121 may periodically request a location update from the client 306 in order to ensure the client 306 is still active and the reported geolocation information is current.

If the preferences of the client 306 and/or user indicate, then the client 306 may receive communications requests from other parties. The communication requests may contain information about the other party such as name, location, language, type of communication sought (e.g. video, audio, instant message, multiparty call, etc.), purpose for the communication, etc. Upon receiving such a request, the communications application 365 on the client 306 may provide notice of the request and prompt the user to accept or reject the request.

If the communication request is accepted by the user, then the communications application 365 notifies the network interface service 121 of the acceptance and the clients 306 begin negotiating to establish a communications link between them. The network interface service 121 may provide each client 306 with the network address information of the other client(s) 306 with which communication is accepted. The communication session among the parties may occur directly via the established communication links without using the server 303 as an intermediary. When the client 306 wishes to exit the communication session, the communications application 365 notifies the network interface service 121 and negotiates with the other client 306 to terminate the communication link to the client 306.

The user may wish to search for other parties with which to communicate. Using the communications application 365, the user may search for other parties based on location, such as latitude/longitude, city/state/country, landmark, postal code, or telephone area code, etc. and/or other criteria, such as name, language, communication capabilities, etc. Alternatively or in addition, the user may use a web browser or other application to access the network interface service 121 and carry out the search. Once the search query is issued to the network interface service 121 by communications application 365 or other application, the query is forwarded to the search service 123.

The search service 123 may then use the location translation service 125 to translate the location specified in the query, as well as any vicinity specified, into the bounds of the location sought in a variety of coordinate systems that may be reported by other parties. The location translation service 125 may refer to the location translations 140 as a reference to determine the bounds of specified locations. Using the location bounds in a variety of coordinate systems, the search service identifies the user accounts 134 that are willing to receive calls that are also within the bounds of the location specified.

As a non-limiting example, if a user sought to find another party within five miles of Haleiwa, Hawaii, USA, then the location translation service 125 would identify the bounds of this location as specified in various coordinate systems. Therefore, the search service 123 would identify a party reporting a location of N 21° 38.45′, W 158° 3.8′ as being within the location specified, even though the locations were specified through different coordinate systems. The search service 123 may further filter the user accounts identified based on search criteria specified by the user, such as name, language, communication capabilities, etc.

Once a target party is identified, the communications application 365 may send a communication request to the network interface service 121. The communication request may contain information about the other party such as name, location, language, type of communication sought (e.g. video, audio, instant message, multiparty call, etc.), purpose for the communication, etc.

If the communication request is accepted by the user, then the communications application 365 notifies the network interface service 121 of the acceptance and the clients 306 begin negotiating to establish a communications link between them. The communication session among the parties may occur directly via the established communication links without using the server 303 as an intermediary. When the client 306 wishes to exit the communication session, the communications application 365 notifies the network interface service 121 and negotiates with the other client 306 to terminate the communication link to the client 306.

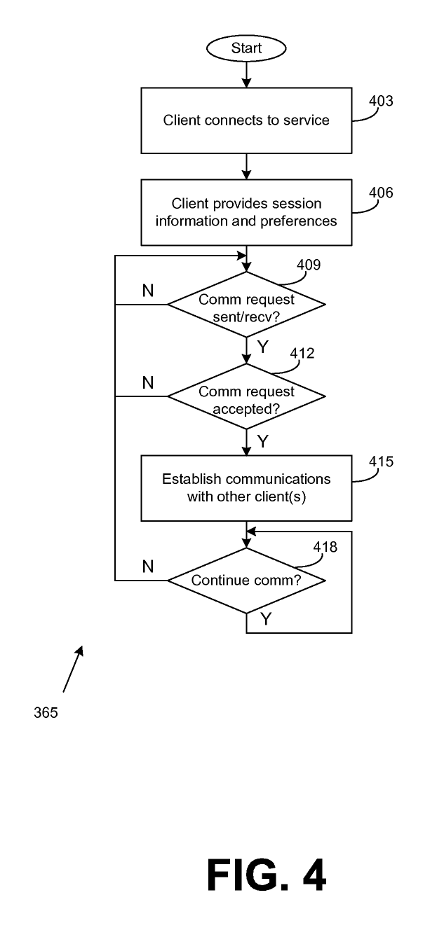

Referring next to FIG. 4, shown is a flowchart that provides one example of the operation of a portion of the communications application 365 according to various embodiments. It is understood that the flowchart of FIG. 4 provides merely an example of the many different types of functional arrangements that may be employed to implement the operation of the portion of the communications application 365 as described herein. As an alternative, the flowchart of FIG. 4 may be viewed as depicting an example of steps of a method implemented in the client 306 (FIG. 3) according to one or more embodiments.

Beginning with box 403, the communications application 365 (FIG. 3) initiates service with to the network interface service 121 (FIG. 1). During execution, the communications application 365 may be configured to supply the user ID 133 (FIG. 1) in order to authenticate with the network interface service 121. Next to box 406, the communications application 365 provides the location of the client 306 (FIG. 1) as determined by the geolocator 161 (FIG. 1). Additionally, the communications application 365 may report the communications capabilities and preferences of the client to the network interface service 121.

Moving to box 409, the communications application 365 may send and/or receive communications requests to/from other parties. The communication requests may contain information about the other party such as name, location, language, type of communication sought (e.g. video, audio, instant message, multiparty call, etc.), purpose for the communication, etc. Upon receiving such a request, the communications application 365 on the client 306 may provide notice of the request and prompt the user to accept or reject the request.

Next, box 412 contemplates a communications request sent by the client 306 being accepted by another party, or, alternatively, the client 306 accepting a communications request sent by another party.

Moving to box 415, the communication request is accepted, the network interface service 121 is notified and the communications application 365 in the clients 306 begin negotiating to establish a communications link between them. The communication session among the clients 306 may occur directly without using the server 303 as an intermediary.

Moving to box 418, when the client 306 wishes to exit the communication session, the communications application 365 notifies the network interface service 121 and negotiates with the client 306 to terminate the communication link to the client 306. Thereafter, the process continues until it is interrupted.

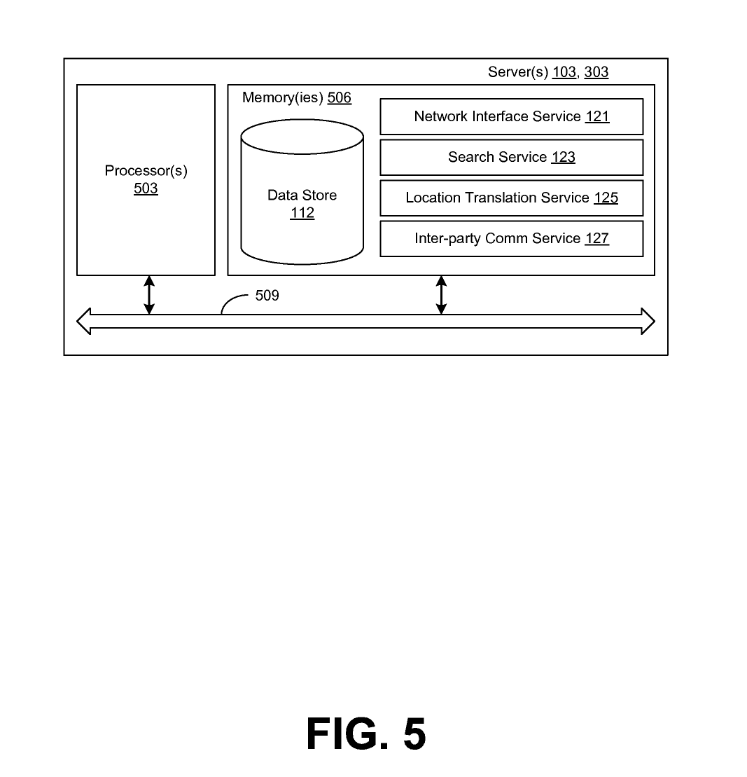

With reference to FIG. 5, shown is a schematic block diagram of the servers 103 and 303 according to an embodiment of the present disclosure. The servers 103 and 303 each include at least one processor circuit, for example, having a processor 503 and a memory 506, both of which are coupled to a local interface 509. To this end, the servers 103 and 303 may each comprise, for example, at least one server computer or like device. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are network interface service 121, search service 123, location translation service 125, inter-party communication service 127, and potentially other applications and services. Also stored in the memory 506 may be a data store 112 and other data. In addition, an operating system may be stored in the memory 506 and executable by the processor 503.

It is understood that there may be other applications that are stored in the memory 506 and are executable by the processors 503 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and the memory 506 may represent multiple memories 506 that operate in parallel processing circuits, respectively. In such a case, the local interface 509 may be an appropriate network 109 (FIG. 1) that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

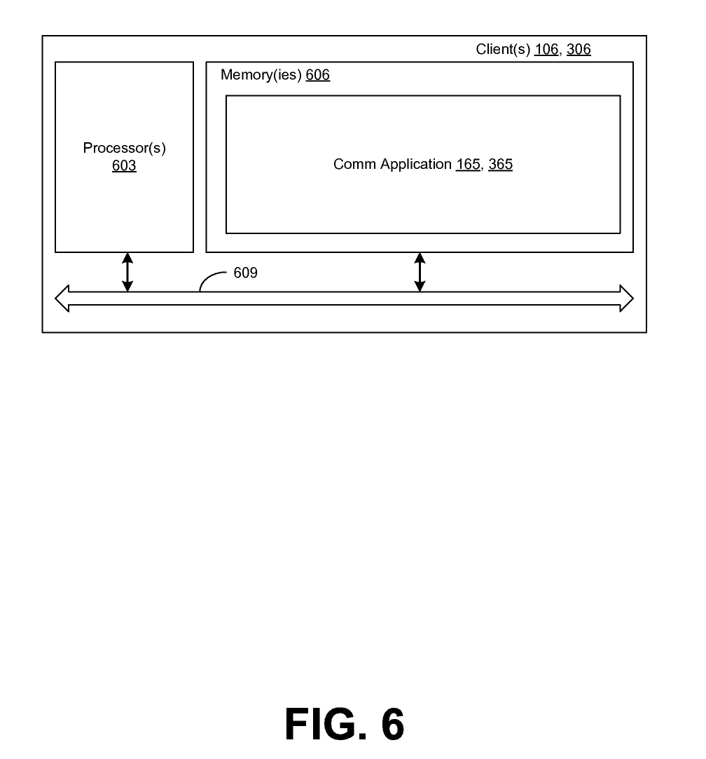

With reference to FIG. 6, shown is a schematic block diagram of the clients 106 and 306 according to an embodiment of the present disclosure. The clients 106 and 306 each include at least one processor circuit, for example, having a processor 603 and a memory 606, both of which are coupled to a local interface 609. To this end, the clients 106 and 306 may comprise, for example, at least one computer or like client device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are communications application 165, communications application 365 and potentially other applications. In addition, an operating system may be stored in the memory 606 and executable by the processor 603.

It is understood that there may be other applications that are stored in the memory 606 and are executable by the processors 603 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network 109 (FIG. 1) that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the network interface service 121, search service 123, location translation service 125, inter-party communication service 127, communications application 165, communications application 365 and potentially other applications, services and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 2 and 4 show the functionality and operation of an implementation of portions of the communications application 165 and communications application 365 (FIGS. 1 and 3), respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 2 and 4 a specific order of execution, it is understood that the order of execution may differ from that which is depicted. For example, the order of execution of two or more blocks may be scrambled relative to the order shown. Also, two or more blocks shown in succession in FIGS. 2 and 4 may be executed concurrently or with partial concurrence. Further, in some embodiments, one or more of the blocks shown in FIGS. 2 and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including network interface service 121, search service 123, location translation service 125, inter-party communication service 127, communications application 165 and communications application 365, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a first mobile device, comprising:
code that transmits, via a network, authentication data to a server device, the authentication data comprising an authentication credential for a first user of the first mobile device;
code that transmits, via the network, a communication preference for the first mobile device to the server device, the communication preference comprising an availability and a location for the first mobile device, the location being provided by a location sensor in the first mobile device;
code that obtains, via the network, a communication request initiated by a second mobile device, the communication request being an invitation to participate in a multimedia conference with a second user of the second mobile device, the communication request comprising a network address of the second mobile device;
code that transmits, via the network, a communication acceptance to the server device, the communication acceptance being transmitted in response to an acceptance of the communication request by the first user; and
code that initiates, via the network, the multimedia conference with the second mobile device, a communication link facilitating the multimedia conference, the communication link being initiated by the first mobile device using the network address of the second mobile device.

2. The non-transitory computer-readable medium of claim 1, wherein the network is a wireless network.

3. The non-transitory computer-readable medium of claim 1, wherein the program further comprises code that transmits, via the network, a multiparty communication request to the server device, the multiparty communication request being a multiparty invitation for a third client device to participate in the multimedia conference with the first and second users, the communication request comprising a network address of the first mobile device.

4. A first mobile communication device, comprising:
a processor; and
a communications application executable by the processor, the communications application comprising:
logic that transmits, via a network, a location of the first mobile communication device to a server device;
logic that obtains, via the network, a communication request initiated by a second client device; and
logic that establishes, via the network, a conference with the second client device, a communication link facilitating the conference, the communication link traversing the server device.

5. The first mobile communication device of claim 4, wherein the conference comprises a video transmission.

6. The first mobile communication device of claim 4, further comprising logic that transmits a communication acceptance in response to the communication request, the conference being initiated in response to the communication acceptance.

7. The first mobile communication device of claim 4, wherein the location is determined by a location sensor in the first mobile communication device.

8. The first mobile communication device of claim 4, further comprising logic that transmits session data to the server device, the session data comprising an authentication credential for a user and a communication preference for the user.

9. The first mobile communication device of claim 8, wherein the session data further comprises a communication capability of the first mobile communication device.

10. The first mobile communication device of claim 4, wherein the first mobile communication device is a smartphone.

11. The first mobile communication device of claim 4, wherein at least one other client device participates in the conference.

12. A method, comprising the steps of:
transmitting, via a network interface of a first client device, a location of the first client device to a server device;
transmitting, via the network interface, a communication request for a second client device; and
establishing, via the network interface, a conference with the second client device, a communications link facilitating the conference being established between the first and second client devices without traversing the server device.

13. The method of claim 12, further comprising the step of obtaining, in the first client device, a network address of the second client device, the network address being used to establish the communications link.

14. The method of claim 12, further comprising the step of identifying, in the first client device, the second client device based upon a search of a plurality of client devices available for the conference, the second client device being one of the client devices.

15. The method of claim 14, wherein the search is based at least upon the location reported by the client devices.

16. The method of claim 14, wherein the search is based at least upon a communication capability reported by the client devices.

17. The method of claim 12, wherein the location is determined by a location sensor in the first client device.

18. The method of claim 12, further comprising the step of transmitting, via the network interface, session data to the server device, the session data comprising an authentication credential for a user and a communication availability for the user.

19. The method of claim 12, wherein the conference comprises a multimedia transmission, the multimedia transmission comprising an audio segment and a video segment.

20. The method of claim 12, wherein at least one other client device participates in the conference.
